(19) United States
(12) Patent Application Publication
(10) Pub. No.: US 2014/0195445 A1
(43) Pub. Date: Jul. 10, 2014

(54) SYSTEM AND METHOD FOR COMPLIANCE RISK MITIGATION

(71) Applicant: INTERNATIONAL BUSINESS MACHINES CORPORATION, Armonk, NY (US)

(72) Inventors: Tamer E. Abuelsaad, Somers, NY (US); Paul R. Bastide, Boxford, MA (US); Damian E.A. Garcia, Martinez, AR (US); Juliana M. Leong, Spring Hill, FL (US)

(73) Assignee: International Business Machines Corporation, Armonk, NY (US)

(21) Appl. No.: 13/734,257

(22) Filed: Jan. 4, 2013

(51) Int. Cl. G06Q 30/00

(52) U.S. Cl. CPC G06Q 30/018
USPC 705/317

(57) ABSTRACT

An approach for handling a complain issue due to absence is provided. The approach includes a computer system identifying a compliance issue. The computer system attributes the compliance issue to a first employee availability. In addition, the computer system identifies a deadline for resolving the compliance issue. Furthermore, the computer system mitigates the compliance issue based on the first employee availability and identified deadline

### FIELD OF THE INVENTION

The present invention relates generally to mitigation of compliance risk, and more particularly to mitigation of compliance risk based on absence of one or more violators of a compliance policy.

### BACKGROUND

Compliance means conforming to a rule, such as a specification, policy, standard or law. Regulatory compliance describes the goal that corporations or public agencies aspire to achieve in their efforts to ensure that personnel are aware of and take steps to comply with relevant laws and regulations. Furthermore, information technology (IT) systems of organizations rely on employees of the organization to perform tasks or complete organizational goals of the organization, thus complying with policies of the organization. However, if employees are absent from the organization, due to leaves of absence, for short or extended periods of time, the IT systems of the organizations are not adapted to confirm compliance with the organization's policies by the absent employee.

### SUMMARY

In one embodiment, a method is provided for handling a compliance issue due to absence. The method comprises a computer system identifying a compliance issue. The method further comprises, the computer system attributing the compliance issue to a first employee availability. The method further comprises, the computer system identifying a deadline for resolving the compliance issue. The method further comprises, the computer system mitigating the compliance issue based on the first employee availability and identified deadline.

In another embodiment, a computer system is provided for handling a compliance issue due to absence. The computer system comprises one or more processors, one or more computer-readable memories, one or more computer-readable tangible storage devices and program instructions which are stored on at least one of the one or more storage devices for execution by at least one of the one or more processors via at least one of the one or more memories. The computer system further comprises program instructions to identify a compliance issue. The computer system further comprises, program instructions to attribute the compliance issue to a first employee availability. The computer system further comprises, program instructions to identify a deadline for resolving the compliance issue. The computer system further comprises, program instructions to mitigate the compliance issue based on the first employee availability and identified deadline.

In yet another embodiment, a computer program product is provided for handling a compliance issue due to absence. The computer program product comprises one or more processors, one or more computer-readable memories, one or more computer-readable tangible storage devices and program instructions which are stored on at least one of the one or more storage devices for execution by at least one of the one or more processors via at least one of the one or more memories. The computer program product further comprises program instructions to identify a compliance issue. The computer program product further comprises, program instructions to attribute the compliance issue to a first employee availability. The computer program product further comprises, program instructions to identify a deadline for resolving the compliance issue. The computer program product further comprises, program instructions to mitigate the compliance issue based on the first employee availability and identified deadline.

### BRIEF DESCRIPTION OF THE SEVERAL VIEWS OF THE DRAWINGS

Novel characteristics of the invention are set forth in the appended claims. The invention itself, however, as well as preferred mode of use, further objectives, and advantages thereof, will be best understood by reference to the following detailed description of the invention when read in conjunction with the accompanying Figures, wherein like reference numerals indicate like components, and:

FIG. 1 is a functional block diagram of a compliance risk mitigation system, in accordance with an embodiment of the present invention.

FIG. 2 is a functional block diagram illustrating program components of client devices in accordance with embodiments of the present invention.

FIG. 3 is a functional block diagram illustrating program components of a server device, in accordance with an embodiment of the present invention.

FIG. 4 is a flowchart depicting steps performed by a server program in accordance with embodiments of the present invention.

FIG. 5 illustrates a block diagram of components of a computer system in accordance with embodiments of the present invention.

### DETAILED DESCRIPTION

Embodiments of the present invention will now be described in detail with reference to the accompanying drawings.

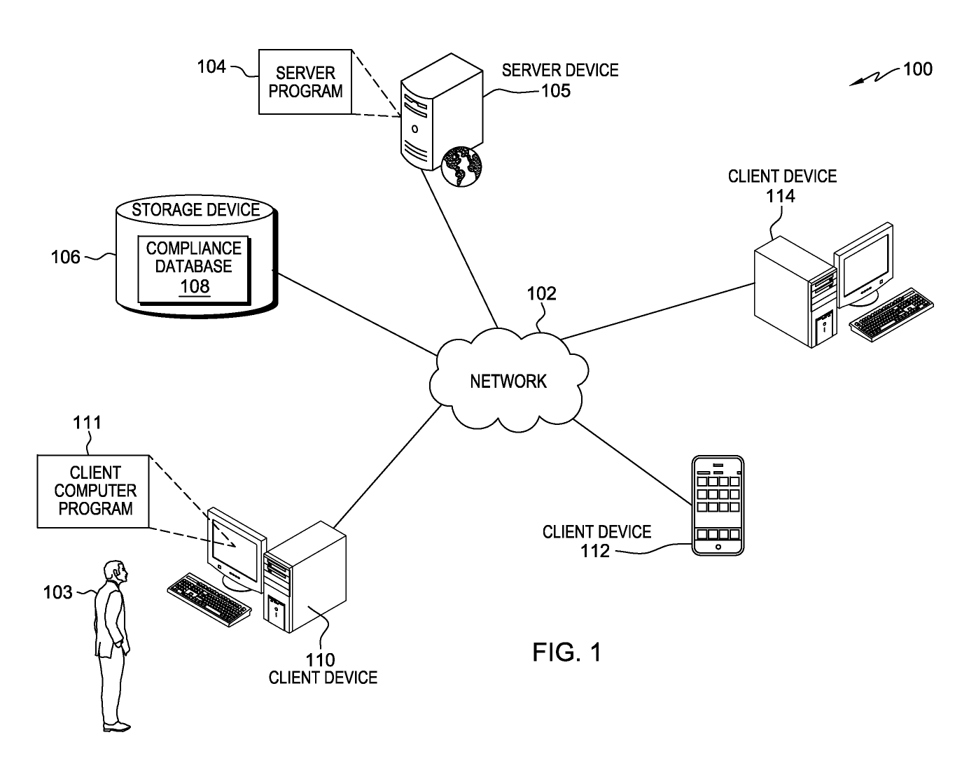

FIG. 1 is a functional block diagram illustrating compliance risk mitigation system 100, in accordance with an embodiment of the present invention. Compliance risk mitigation system 100 includes server device 105, storage device 106 containing compliance database 108, and client devices 110, 112, and 114. Server device 105, storage device 106, and client devices 110, 112, and 114 can all be interconnected over network 102.

Server device 105 can be, for example, a management server, a web server, or any other electronic device or computer capable of receiving and sending data. Server device 105 includes server program 104. Server program 104 is a software system application that identifies compliance issues pertaining to compliance policies of an organization. In one embodiment of the present invention, server program 104 remediates the identified compliance issues of the organization. In particular, server program 104 detects a system or individual of the organization that violates the compliance policies, identifies a deadline to remediate or resolve the compliance issue, determines the likelihood of remediating the compliance issue, and escalates or redirects remediation of the compliance issue to an another server system of compliance risk mitigation system 100, including for example, an information technology (IT) server of the organization, wherein the IT server can utilize an alternative path or process to remediate the compliance issues, as described in further details below, in accordance with embodiments of the present invention.

Storage device 106 can be any type of storage device, storage server, storage area network, redundant array of independent discs (RAID), cloud storage service, or any type of data storage. Compliance database 108 can be a database of documents, including, for example, documents comprising compliance policies of an organization.

In the depicted embodiment, each of client devices 110, 112, and 114 can be a laptop, tablet, or netbook personal computer (PC), a desktop computer, a mainframe or mini computer, a personal digital assistant (PDA), or a smart phone such as a Blackberry®. Each of client devices 110, 112, and 114 includes client computer program 111. Client computer program 111 can be a web browser, a standalone web page search application, or part of a service that attributes compliance issues to a system or an individual, including, for example, an employee of an organization who violates or non-complies with compliance policies of the organization.

Network 102 may include one or more networks of any kind that may provide communications links between various devices and computers connected together within compliance risk mitigation system 100. Network 102 may include connections, such as wire, wireless communication links, or fiber optic cables. In one example, network 102 is the Internet, a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Network 102 may also be implemented as a number of different types of networks, such as for example, an intranet, a local area network (LAN), or a wide area network (WAN). Client devices 110, 112, and 114 can communicate over network 102 with server device 105 to facilitate remediation of compliance issues of an organization, in accordance with embodiments of the present invention. Employee 103 can be an employee of the organization that violates or does not comply with compliance policies of the organization, in accordance with embodiments of the present invention.

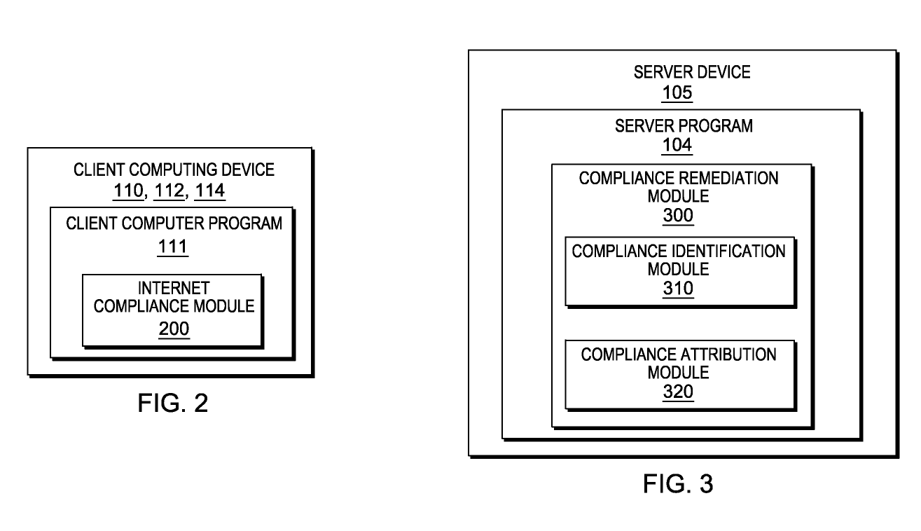

FIG. 2 is a functional block diagram illustrating components of client devices 110, 112, and 114. Client computer program 111 can, among other things, retrieve and display content accessible via network 102, such as web pages. In at least one embodiment, client computer program 111 is a web browser. The web browser can be a software application for retrieving, presenting and traversing information resources on the World Wide Web or an Intranet network service with an organization. In one aspect, an information resource is identified by a Uniform Resource Identifier (URI) of the web browser of client computer program 111, and wherein the information resource may be a web page, image, video or other piece of content. Furthermore, hyperlinks, present in the information resource can enable employee 103 to easily navigate his or her browser to related information resources pertaining to violating or non-complying with compliance polices of the organization within compliance risk mitigation system 100.

In another aspect, the Intranet service of the web browser uses Internet Protocol technology to share information, operational systems, or computing service pertaining to compliance policies of systems or individuals, includes for example, employee 103 of the organization, in accordance with embodiments of the invention. Examples of web browsers include Internet Explorer® (Internet Explorer is a trademark of Microsoft Inc., in the United States, other countries or both), Firefox® (Firefox is a trademark of Mozilla Corporation, in the United States, other countries or both), Safari® (Safari is a trademark of Apple, Inc. in the United States, other countries or both) and Google Chrome™ (Google Chrome is a trademark of Google, Inc. in the United States, other countries or both). Client computer program 111 includes Intranet compliance module 200.

In at least one embodiment, Intranet compliance module 200 is a web browser plugin/add-on that extends the functionality of client computer program 111 by adding additional user interface elements to a user interface of client computer program 111. The additional user interface attributes the compliance issue of the organization to employee 103. Furthermore, compliance policies of the organization can be defined by the organization in Intranet compliance module 200. The Internet or Intranet web page received in client computer program 111 can include program code, such as HyperText Markup Language (HTML) code or JavaScript code that, when executed, adds the additional user interface elements to the user interface of client computer program 111, in accordance with embodiments of the present invention. In at least one embodiment, Intranet compliance module 200 attributes the compliance issues of the compliance policies to employee 103, who violates or non-complies with the compliance policies of the organization on Intranet compliance module 200. For example, remediation of an identified compliance issue by server program 104 involves an action from an individual who non-complies with the compliance policies of the organization. If employee 103 is absent, for example, due to vacation, employee 103 cannot take action to comply with the compliance policies. Therefore, due to the lack of action by employee 103 in complying with the compliance policies, Intranet compliance module 200 attributes the compliance policies to employee 103, and transmits the attributed compliance issue of employee 103 to server program 104, wherein server program 104 remediates the compliance issue or compliance risk, in accordance with embodiments of the present invention.

FIG. 3 is a functional block diagram illustrating program components of server device 105, in accordance with an embodiment of the present invention.

Server program 104 includes compliance remediation module 300. Compliance remediation module 300 includes compliance identification module 310 and compliance attribution module 320.

Compliance identification module 310 identifies a compliance issue of an organization. For instance, if compliance policies of the organization are violated, compliance identification module 310 examines individuals or systems that can be attributed to violated compliance policies. For example, in the case that employee 103 must change password of a system pertaining to the organization every 30 days on client computer program 111, compliance identification module 310 audits the system of employee 103 to determine whether the password was changed around the 30 days period. However, if compliance identification module 310 determines that the password was not changed, compliance identification module 310 generates a compliance violation report of employee 103, and transmits the report to compliance database 108 of storage device 106 for future retrieval by server program 104, in accordance with embodiments of the present invention.

Compliance attribution module 320 retrieves the compliance reports of compliance database 108, periodically, randomly, or event based retrieval, to detect violation of the compliance policies reported by compliance identification module 310. In one aspect of the present invention, compliance attribution module 320 detects the employees that are responsible for violating the compliance policies. For example, compliance attribution module 320 detects the specific employee based on whether the employee was absent, and failed to comply with the compliance policies of the organization. In one example, compliance attribution module 320 detects the violated compliance policies based on status detection of employee 103. In particular, the status detection of employee 103 can be based on Intranet mail detection of employee 103 on computer client program 111. The mail status detection mechanism of employee 103 can be based on detection of percentage of unread emails of employee 103, detection of lack of outgoing emails of employee 103, or detection of out of office notification of employee 103.

In one aspect, compliance attribution module 320 also detects previous or current presence of employee 103 authentication on the organization's instant message communication system, including, for example, employee authentication of Lotus® Notes® (Lotus and Notes are trademarks of International Business Machines, in the United States, other countries, or both). Compliance attribution module 320 can also detect authentication or login presence or lack thereof, of employee 103 on a social network of the organization.

In another aspect, compliance attribution module 320 also identifies a deadline to remediate or resolve the compliance issue, determine the likelihood of remediating the compliance issue, escalate or redirect remediation of the compliance issue to an another server, including for example, an information technology (IT) server of the organization of compliance risk mitigation system 100, wherein the IT server can utilize an alternative path or process to remediation of the compliance issue. Furthermore, if compliance attribution module 320 attributes the absence of employee 103, compliance attribution module 320 detect another employee who violates same or similar compliance policies of the organization pertaining to employee 103, and interacting with the newly detected employee to remediate the violated compliance policy. Compliance attribution module 320 can also interact with one or more assistants or managers of employee 103 to remediate the violated compliance policies. Further, compliance attribution module 320 can also reschedule status check of detecting violation of the compliance policy, or warn against possible violation of the compliance, in accordance with embodiments of the present invention.

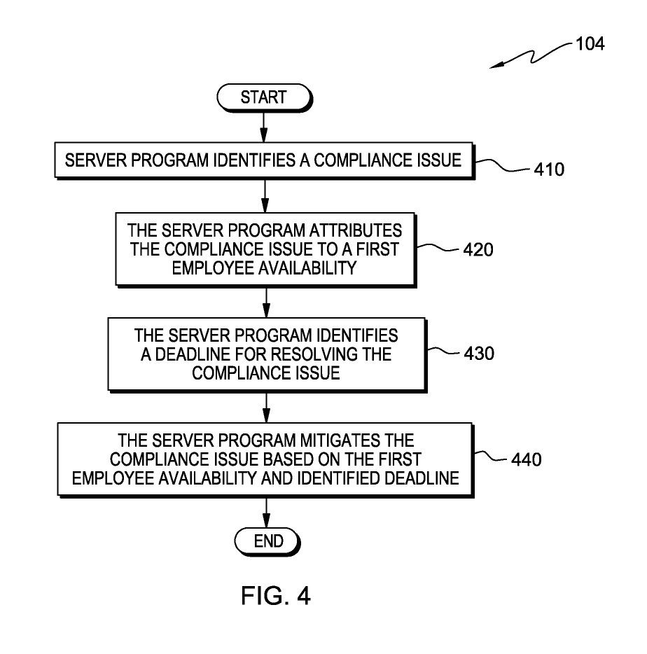

FIG. 4 is a flowchart depicting steps performed by server program 104 in accordance with embodiments of the present invention.

In step 410, server program 104 identifies a compliance issue pertaining to compliance policies of an organization. In step 420, server program 104 attributes the compliance issue to a first employee of the organization based on availability of the first employee, including, for example, whether the first employee is on short or extended leave of absence from the organization. In step 430, server program 104 identifies a deadline for resolving violation of the compliance issue by the employee. In step 440, server program 104 mitigates the compliance issue based on the first employee's availability and identified deadline.

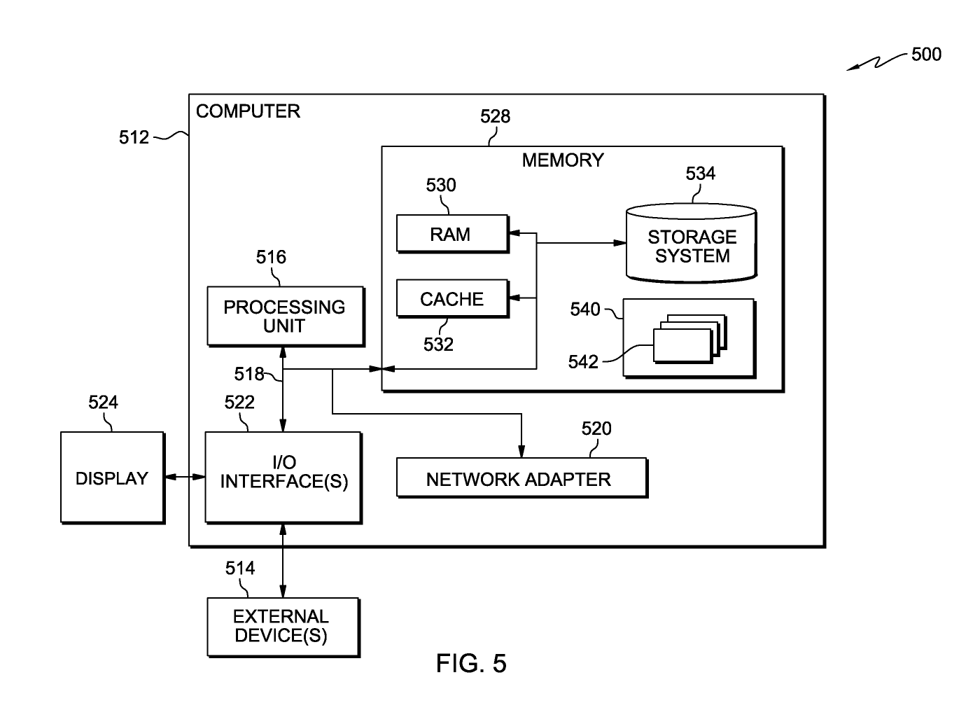

FIG. 5 is a functional block diagram of a computer system, in accordance with an embodiment of the present invention.

Computer system 500 is only one example of a suitable computer system and is not intended to suggest any limitation as to the scope of use or functionality of embodiments of the invention described herein. Regardless, computer system 500 is capable of being implemented and/or performing any of the functionality set forth hereinabove. In computer system 500 there is computer 512, which is operational with numerous other general purpose or special purpose computing system environments or configurations. Examples of well-known computing systems, environments, and/or configurations that may be suitable for use with computer 512 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like. Each one of client devices 110, 112, 114, and server device 105 can include or can be implemented as an instance of computer 512.

Computer 512 may be described in the general context of computer system executable instructions, such as program modules, being executed by a computer system. Generally, program modules may include routines, programs, objects, components, logic, data structures, and so on that perform particular tasks or implement particular abstract data types. Computer 512 may be practiced in distributed cloud computing environments where tasks are performed by remote processing devices that are linked through a communications network. In a distributed cloud computing environment, program modules may be located in both local and remote computer system storage media including memory storage devices.

As further shown in FIG. 5, computer 512 is shown in the form of a general-purpose computing device. The components of computer 512 may include, but are not limited to, one or more processors or processing units 516, memory 528, and bus 518 that couples various system components including memory 528 to processing unit 516.

Bus 518 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer 512 typically includes a variety of computer system readable media. Such media may be any available media that is accessible by computer 512, and includes both volatile and non-volatile media, and removable and non-removable media.

Memory 528 includes computer system readable media in the form of volatile memory, such as random access memory (RAM) 530 and/or cache 532. Computer 512 may further include other removable/non-removable, volatile/non-volatile computer system storage media. By way of example only, storage system 534 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 518 by one or more data media interfaces. As will be further depicted and described below, memory 528 may include at least one program product having a set (e.g., at least one) of program modules that are configured to carry out the functions of embodiments of the invention.

Client computer program 111 and server program 104 can be stored in memory 528 by way of example, and not limitation, as well as an operating system, one or more application programs, other program modules, and program data. Each of the operating system, one or more application programs, other program modules, and program data or some combination thereof, may include an implementation of a networking environment. Program modules 542 generally carry out the functions and/or methodologies of embodiments of the invention as described herein. Each one of Client computer program 111 and server program 104 are implemented as or are an instance of program 540.

Computer 512 may also communicate with one or more external devices 514 such as a keyboard, a pointing device, etc., as well as display 524; one or more devices that enable a user to interact with computer 512; and/or any devices (e.g., network card, modem, etc.) that enable computer 512 to communicate with one or more other computing devices. Such communication occurs via Input/Output (I/O) interfaces 522. Still yet, computer 512 communicates with one or more networks such as a local area network (LAN), a general wide area network (WAN), and/or a public network (e.g., the Internet) via network adapter 520. As depicted, network adapter 520 communicates with the other components of computer 512 via bus 518. It should be understood that although not shown, other hardware and/or software components could be used in conjunction with computer 512. Examples, include, but are not limited to: microcode, device drivers, redundant processing units, external disk drive arrays, RAID systems, tape drives, and data archival storage systems, etc.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustrations are implemented by special purpose hardware-based systems that perform the specified functions or acts, or combinations of special purpose hardware and computer instructions.

As will be appreciated by one skilled in the art, embodiments of the present invention may be embodied as a system, method or computer program product. Accordingly, embodiments of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments of the present invention may take the form of a computer program product embodied in one or more computer-readable medium(s) having computer-readable program code embodied thereon.

In addition, any combination of one or more computer-readable medium(s) may be utilized. The computer-readable medium may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that contains, or stores a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that communicates, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing. Computer program code for carrying out operations for embodiments of the present invention may be written in any combination of one or more programming languages, including an object oriented programming language such as Java, Smalltalk, C++ or the like, conventional procedural programming languages such as the “C” programming language, a hardware description language such as Verilog, or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Based on the foregoing a method, system and computer program product for mitigation of compliance risk of an organization, has been described. However, numerous modifications and substitutions can be made without deviating from the scope of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the Figures. Therefore, the present invention has been disclosed by way of example and not limitation.

What is claimed is:

1. A method for handling a compliance issue due to absence, the method comprising:
a computer system identifying a compliance issue;
the computer system attributing the compliance issue to a first employee availability;
the computer system identifying a deadline for resolving the compliance issue; and
the computer system mitigating the compliance issue based on the first employee availability and identified deadline.

2. The method according to claim 1, wherein the step of attributing the compliance issue to the first employee availability further comprises: the computer system monitoring status of the first employee based on mail, login authentication, social network, or calendar of the first employee in an organization.

3. The method according to claim 2 further comprising: the computer system analyzing the status for modifications of the monitored status of the first employee including a return date of the first employee based on the monitored status of the first employee.

4. The method according to claim 3 further comprising: the computer system modifying the return date of the based on a predetermined threshold of deadline to modify the return date of a compliance issue of an organization.

5. The method according to claim 3 further comprising: the computer system redirecting the analyzed the status for modifications of the monitored status of the first employee to a second employee selected from a group consisting of a co-owner, assistant, delegate or manager of an organization.

6. The method according to claim 1 wherein the step of attributing the compliance issue to the first employee availability, further comprises: the computer system detecting user interactions of the first employee.

7. The method according to claim 6, wherein the detected user interaction of the first employee includes detection of compliance policies of an organization.

8. A computer system for handling a compliance issue due to absence, the computer system comprising:
one or more processors, one or more computer-readable memories, one or more computer-readable tangible storage devices and program instructions which are stored on at least one of the one or more storage devices for execution by at least one of the one or more processors via at least one of the one or more memories, the program instructions comprising:
program instructions to identify a compliance issue;
program instructions to attribute the compliance issue to a first employee availability;
program instructions to identify a deadline for resolving the compliance issue; and
program instructions to mitigate the compliance issue based on the first employee availability and identified deadline.

9. The computer system according to claim 8, wherein program instructions to attribute the compliance issue to the first employee availability further comprises: program instructions to monitor status of the first employee based on mail, login authentication, social network, calendar of the first employee in an organization.

10. The computer system according to claim 9 further comprising: the computer system analyzing the status for modifications of the monitored status of the first employee including a return date of the first employee based on the monitored status of the first employee.

11. The computer system according to claim 10 further comprising: program instructions to modify the return date of the based on a predetermined threshold of deadline to modify the return date of a compliance issue of an organization.

12. The computer system according to claim 10 further comprising: program instructions to redirect the analyzed the status for modifications of the monitored status of the first employee to a second employee selected from a group consisting of a co-owner, assistant, delegate or manager of an organization.

13. The computer system according to claim 9 wherein program instructions to attribute the compliance issue to the first employee availability, further comprises: program instructions to detect user interactions of the first employee.

14. The computer system according to claim 13, wherein the detected user interaction of the first employee includes detection of compliance policies of an organization.

15. A computer program product for handling a compliance issue due to absence, the computer program product comprising:
one or more computer-readable tangible storage devices and program instructions stored on at least one of the one or more storage devices, the program instructions comprising:
program instructions to identify a compliance issue;
program instructions to attribute the compliance issue to a first employee availability;
program instructions to identify a deadline for resolving the compliance issue; and
program instructions to mitigate the compliance issue based on the first employee availability and identified deadline.

16. The computer program product according to claim 15, wherein program instructions to attribute the compliance issue to the first employee availability further comprises: program instructions to monitor status of the first employee based on mail, login authentication, social network, calendar of the first employee in an organization.

17. The computer program product according to claim 16 further comprising: the computer program product analyzing the status for modifications of the monitored status of the first employee including a return date of the first employee based on the monitored status of the first employee.

18. The computer program product according to claim 17 further comprising: program instructions to modify the return date of the based on a predetermined threshold of deadline to modify the return date of a compliance issue of an organization.

19. The computer program product according to claim 17 further comprising: program instructions to redirect the analyzed the status for modifications of the monitored status of the first employee to a second employee selected from a group consisting of a co-owner, assistant, delegate or manager of an organization.

20. The computer program product according to claim 15, wherein program instructions to attribute the compliance issue to the first employee availability, further comprises: program instructions to detect user interactions of the first employee.
